(19) United States
(12) Patent Application Publication
(10) Pub. No.: US 2009/0110982 A1
(43) Pub. Date: Apr. 30, 2009

(54) Sensing pipe and fuel cell system using the same

(76) Inventors: Seong-Kee Yoon, Suwon-si (KR); Jung-Kum Park, Suwon-si (KR); Hye-Jung Cho, Suwon-si (KR); In-Seob Song, Suwon-si (KR); Sang-Min Jeon, Suwon-si (KR); Dong-Kyu Lee, Suwon-si (KR); Myung-Sun Yoo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/218,522

(22) Filed: Jul. 15, 2008

(30) Foreign Application Priority Data
Oct. 30, 2007 (KR) 10-2007-0109806

(51) Int. Cl. H01M 8/04; G01N 29/02

(52) U.S. Cl. 429/22; 73/24.01; 73/64.53

(57) ABSTRACT

A fuel cell system including a quartz crystal microbalance (QCM) concentration sensor, and in particular, comprising a bypass channel structure useful for installing a QCM concentration sensor to a fuel cell system. The fuel cell system includes a fuel cell stack generating electric energy by an electrochemical reaction of a hydrogen-containing fuel and an oxidant, a fuel cell including a fuel supplying unit supplying the hydrogen-containing fuel to the fuel cell stack, a QCM concentration sensing unit for measuring the concentration of a fluid in the fuel cell, and a drive controlling unit for controlling the operation of the fuel cell according to an output of the QCM concentration sensing unit.

### CROSS-REFERENCE TO RELATED APPLICATIONS

This application claims priority to and the benefit of Korean Patent Application No. 10-2007-0109806, filed on Oct. 30, 2007 in the Korean Intellectual Property Office, the entire content of which is incorporated herein by reference.

### BACKGROUND

1. Technical Field

The present disclosure relates to a fuel cell system including a QCM concentration sensor, and in particular, to a bypass channel structure for sensor installation that can be used to install a QCM concentration sensor to a fuel cell system and a fuel cell system using the same.

2. Discussion of Related Art

A fuel cell is a power generation system generating electric energy by means of an electrochemical reaction between oxygen and hydrogen contained in hydrocarbon-based material such as methanol, ethanol, and/or natural gas.

Fuel cells are divided into phosphoric acid fuel cells, molten carbonate fuel cells, solid oxide fuel cells, polymer electrolyte membrane fuel cells, alkaline fuel cells, etc. in accordance with type of electrolyte used. These respective types of fuel cells operate on the same basic principle, but differ in the type of fuel used, operating temperature, catalyst, electrolyte, etc.

Among these types, polymer electrolyte membrane fuel cells (PEMFC) typically have very high output characteristics, low operating temperatures, and fast starting and response characteristics compared with the other types of fuel cells. Therefore, FEMFC can be advantageously used as transportable power supplies, for example, for portable electronic equipment, or power supplies for transportation, for example, for automobiles, as well as distributed power supplies, for example, as stationary power plants for houses, public buildings, and the like.

### SUMMARY OF THE INVENTION

Embodiments of the present disclosure solve one or more of the problems discussed herein. It is an object to provide a fuel cell system having a concentration sensor capable of accurately measuring the concentration of fuel at low cost.

Also, it is another object to provide a fuel cell system having a concentration sensor capable of rapidly measuring the concentration of fuel in a small structure.

Further, it is still another object to provide a bypass channel structure capable of accurately measuring the concentration of liquid with a small concentration sensor in a pipe in which flow velocity is non-uniform.

Some embodiments provide a fuel concentration sensing device and a fuel cell comprising the fuel concentration sensing device, for example, a direct methanol fuel cell, wherein the sensing device comprises a fuel conduit and a bypass fluidly connected thereto. A sensor is disposed in the bypass loop. The bypass is dimensioned and configured to provide a substantially uniform fluid flow velocity irrespective of the fluid velocity in the fuel conduit. In some embodiments, the bypass comprises a first end fluidly connected to an upstream section of the fuel conduit and a second end fluidly connected to a downstream section of the fuel conduit, and is configured for a substantially one-way flow therethrough. In some embodiments, a vertical dimension of a cross section of the bypass is less than a horizontal dimension of a cross section of the bypass. In some embodiments, the sensor is a quartz crystal microbalance. Some embodiments provide an accurate measurement of a fuel concentration, which is used to optimize the operation of the fuel cell.

In order to accomplish these and other objects, there is provided a fluid-sensing pipe for a fuel cell system including: a main flow field transferring fluid to be sensed; and a bypass channel temporarily shunting some of fluid flowing in the main flow field and mounted therein.

Exemplarily, the bypass channel may include a fluid inlet part coupled to one surface of the main flow field and receiving the liquid field from the main flow field; a fluid outlet partially coupled to the other surface of the main flow field and discharging the fluid to the main flow field; and a partition wall positioned between the bypass channel and the main flow field. The vertical cross sectional area of the bypass channel to the fluid flow direction of the middle region may be wider compared to the cross sectional areas of the fluid inlet part and the fluid outlet part.

The bypass channel may be a plane shape including an axis in a fluid flow direction parallel to the main flow field or may be a rectangular shape or an oval shape with a narrow vertical direction cross section to the flow direction of fluid.

The sensor may be a QCM sensor. Also, the fluid-sensing pipe may further include a sensing region communicating with a region of the bypass channel and having a space where the width of the region is wide.

In order to accomplish the above objects, there is provided a fuel cell system including: a fuel cell including a fuel cell stack generating electric energy by means of the electrochemical reaction of a hydrogen-containing fuel and oxidant, and a fuel supplying unit supplying the hydrogen-containing fuel to the fuel cell stack; a QCM concentration sensing unit for measuring concentration of fluid existing in the fuel cell with a built-in QCM concentration sensor; and a drive controlling unit for controlling the operation of the fuel cell according to the sensing results of the QCM concentration sensing part.

The QCM concentration sensing unit may be a fluid-sensing pipe having the QCM concentration sensor.

The fuel supplying unit may include a fuel tank storing high concentration methanol; and a mixing tank mixing water or non-reaction fuel from the fuel cell stack and the high concentration methanol and supplying the mixed fuel liquid fuel to the fuel cell stack.

In the case of implementing the sensing pipe as the QCM concentration sensing unit, the main flow field of the sensing pipe may be a portion of the pipe positioned between the mixing tank and the anode of the fuel cell stack.

The fuel supplying unit further includes a first flux controller controlling the flow of high concentration methanol transferred from the fuel tank to the mixing tank; a second flux controller controlling the flow of the mixed fuel liquid fuel transferred from the mixing tank to the anode of the fuel cell stack; and a third flux controller controlling the flow of fluid transferred from the fuel cell stack to the mixing tank, wherein the drive controlling unit may control at least one of the first to third flux controllers according to the sensing results of the QCM concentration sensing unit.

Some embodiments provide a fluid-sensing device for measuring a fuel concentration in a fuel cell system, the fluid-sensing device comprising: a main flow field comprising a first end and a second end, and configured for transferring fluid to be sensed from the first end to the second end; a bypass channel fluidly connected to the main flow field, and configured for diverting and returning a portion of fluid therefrom; and a fluid sensor disposed in the bypass channel.

In some embodiments, the sensor is disposed in a middle region of the bypass channel. In some embodiments, the bypass channel comprises: a fluid inlet fluidly coupled proximal to the first end of the main flow field and configured for receiving fluid from the main flow field; a fluid outlet fluidly coupled proximal to the second end of the main flow field and configured for discharging fluid to the main flow field; and a partition wall disposed between the bypass channel and the main flow field. In some embodiments, a cross section of a middle region of the bypass channel is wider than a cross section of the fluid inlet and a cross section of the fluid outlet.

In some embodiments, the sensor comprises a quartz crystal microbalance (QCM) sensor.

In some embodiments, the bypass channel comprises at least one of a rectangular cross section and an oval cross section with respect to the direction of fluid flow, and a vertical dimension of the cross section is narrower than a horizontal dimension of the cross section. Some embodiments further comprise a sensor region in fluid communication with a wide portion of the bypass channel.

Some embodiments provide a fuel cell system comprising: a fuel cell comprising a fuel cell stack operable for generating electric energy by an electrochemical reaction between a hydrogen-containing fuel and oxidant; and a fuel supplying unit fluidly coupled to the fuel cell stack, operable for supplying the hydrogen-containing fuel to the fuel cell stack; a QCM concentration sensing unit comprising a QCM concentration sensor in fluid communication with a fluid in the fuel cell stack, operable for measuring a concentration of the fluid in the fuel cell; and a drive controlling unit coupled to the QCM concentration sensing unit, operable for controlling the operation of the fuel cell according to an output of the QCM concentration sensing unit.

In some embodiments, the QCM concentration sensing unit comprises a main flow field comprising a first end and a second end, and configured for transferring fluid to be sensed from the first end to the second end; a bypass channel fluidly connected to the main flow field, and configured for diverting and returning a portion of the fluid therefrom; and a QCM concentration disposed in the bypass channel. In some embodiments, the sensor is disposed in a middle region of the bypass channel.

In some embodiments, the bypass channel comprises: a fluid inlet fluidly coupled proximal to the first end of the main flow field and configured for receiving fluid from the main flow field; a fluid outlet fluidly coupled proximal to the second end of the main flow field and configured for discharging fluid to the main flow field; and a partition wall disposed between the bypass channel and the main flow field. In some embodiments, a cross section of a middle region of the bypass channel is wider than a cross section of the fluid inlet and a cross section of the fluid outlet.

In some embodiments, the QCM concentration sensing unit comprises a fluid sensing device comprising the QCM sensor disposed therein.

In some embodiments, the bypass channel comprises at least one of a rectangular cross section and an oval cross section respect to the direction of fluid flow, and a vertical dimension of the cross section is narrower than a horizontal dimension. Some embodiments further comprise a sensor region in fluid communication with a wide portion of the bypass channel.

In some embodiments, the fuel supplying unit comprises: a fuel tank configured for storing high concentration methanol; and a mixing tank in fluid communication with the fuel tank and the fuel cell stack, wherein the mixing tank is configured for mixing water and/or unreacted fuel from the fuel cell stack with high concentration methanol from the fuel tank, and supplying the mixed fuel liquid fuel to the fuel cell stack.

In some embodiments, the main flow field comprises a portion of a pipe or conduit fluidly connecting the mixing tank to an anode of the stack.

In some embodiments, the fuel supplying unit further comprises: a first flux controller configured for controlling a flow of high concentration methanol from the fuel tank to the mixing tank; a second flux controller configured for controlling a flow of a mixed fuel liquid fuel from the mixing tank to an anode of the fuel cell stack; and a third flux controller configured for controlling a flow of fluid from the fuel cell stack to the mixing tank, wherein the drive controlling unit controls at least one of the first to third flux controllers according to an output of the QCM concentration sensing unit.

In some embodiments, the third flux controller comprises a condenser fluidly connected to an exhaust outlet of the fuel cell stack and the mixing tank, and configured for condensing fluid from the fuel cell stack into the mixing tank.

Some embodiments further comprise an air pump fluidly connected to the cathode of the fuel cell stack.

### BRIEF DESCRIPTION OF THE DRAWINGS

These and/or other embodiments and features will become apparent and more readily appreciated from the following description of certain exemplary embodiments, taken in conjunction with the accompanying drawings of which:

FIG. 1 is a schematic structure view showing a fuel cell system according to one embodiment;

FIGS. 2A to 2D are views showing structures of a sensing pipe for a fuel cell system according to one embodiment; and

FIGS. 3 is a perspective view showing a flow of internal fluid according to a change in A dimension of FIG. 2D.

### DETAILED DESCRIPTION

Hereinafter, certain exemplary embodiments will be described with reference to the accompanying drawings. Here, when a first element is described as being coupled to a second element, the first element may be not only directly coupled to the second element but may also be indirectly coupled to the second element through one or more third elements. Further, elements that are not essential to a complete understanding are omitted for clarity. Also, like reference numbers refer to like elements throughout.

Hereinafter, certain embodiments will be described in more detailed with reference to the accompanying drawings for ease of practice by those skilled in the art, but can be implemented in different forms not limited to the embodiments described herein.

For example, the embodiments are described below as applied to a direct methanol type fuel cell. However, those skilled in the art will understand that the concept are equally applicable to other types of fuel cell systems, for example, acetic acid fuel cell systems, ethanol fuel cell systems, and/or fuel cell systems using liquid hydrogen storage alloys, for example, a liquid comprising NaBH₄.

Also, in below description, a term “fuel cell stack” is used for convenience. The term “fuel cell stack” as used herein includes any stack comprising stack-type unit cells, flat panel-type unit cells, and/or a unit stack comprising a single unit cell.

One type of fuel cell is the direct methanol fuel cell (DMFC), which directly uses a liquid-phase fuel supplied to the stack. Since a direct methanol fuel cell, unlike a polymer electrolyte membrane fuel cell, does not use a reformer for producing hydrogen from the fuel, it is more amenable to miniaturization.

A direct methanol fuel cell may include a stack, a fuel tank, and a fuel pump, etc. The stack typically comprises several to several tens of unit fuel cells, each comprising a membrane electrode assembly (MEA) and separator stacked together. Herein, the membrane electrode assembly comprises an anode and a cathode disposed on each side of an electrolyte membrane with the polymer electrolyte membrane disposed therebetween.

Meanwhile, the operating efficiently of a direct methanol fuel cell can vary greatly depending on the molar concentration of the fuel supplied to the anode electrode and the cathode electrode. For example, if the molar concentration of the fuel supplied to the anode electrode is too high, the volume of the fuel transferred from the anode side to the cathode side increases due to limitations of current polymer electrolyte membranes, which generates a counter-electromotive force from a reaction of fuel and oxidant at the cathode, thereby reducing the output. Such a direct methanol fuel cell has optimal operating efficiency at a predetermined fuel concentration according to the configuration and characteristics thereof. Therefore, in a direct methanol fuel cell system, a scheme properly controlling the molar concentration of the fuel is desirable in order to safely and effectively operate the system.

A direct methanol fuel cell stack can include a device or means for measuring the concentration of fluid in components thereof, such as a stack, a fuel tank, a recycle tank, or fuel flowing into a pipe between the components. In this case, the driving state of the fuel cell system can be estimated by measuring the concentration of the fuel, and the driving efficiency of the fuel cell system can be raised by controlling the operation of the components according to the estimated fuel concentration.

Further, concentration sensing of a liquid is useful even in polymer electrolyte membrane fuel cell systems, which form condensate in the cathode side discharge.

As described above, in a fuel cell system, measuring the concentration of the liquid fuel plays a very important role in improving the performance of the fuel cell system. However, in order to use the measurement apparatus for measuring the concentration of fluid in the small fuel cell system, the concentration measurement apparatus should optimally satisfy many requirements such as smaller size, accurate concentration sensing, rapid concentration sensing, low cost, etc.

In order to satisfy these and other requirements, known concentration sensors such as an ultrasound concentration sensor including a polymer absorptive concentration sensor, an ultrasound generator and a detector, a resistance measuring concentration sensor for measuring resistance between electrodes in a fluid, etc., have been proposed. However, existing concentration sensors applied to the fuel cell have, up to now, not satisfied all requirements described above.

Further, a small concentration sensor reacts to the flow velocity of the fluid to be measured. Therefore, it has been very difficult to install a small concentration sensor to a fuel supplying pipe, etc. in the fuel cell system, for which concentration measurement is most desired.

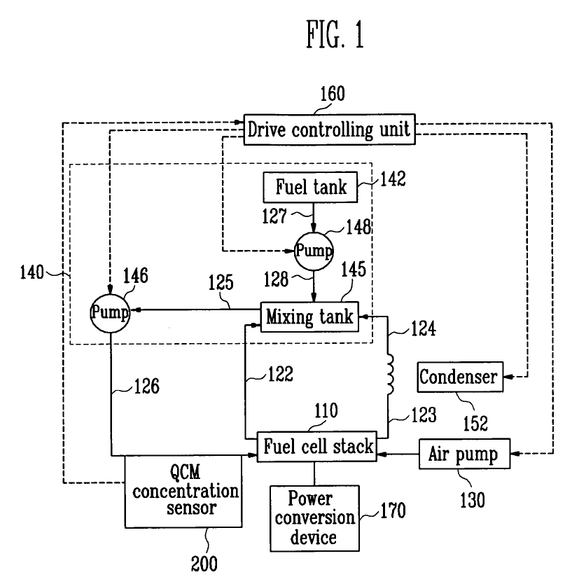

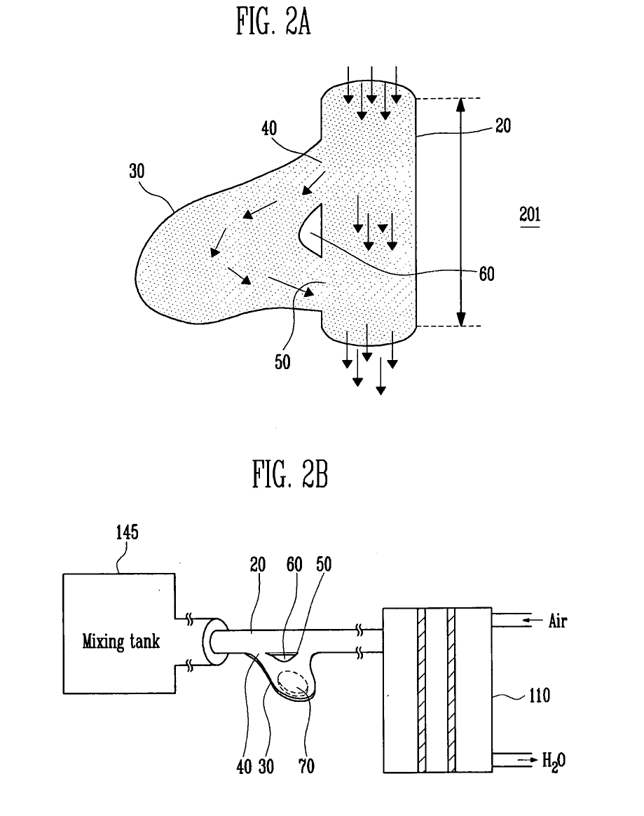

A fuel cell system shown schematically in FIG. 1 includes a fuel tank 142 in which high concentration methanol is stored; a fuel cell stack 110 generating electric energy by the electrochemical reaction of methanol and oxygen; a mixing tank 145 supplying a mixture comprising high concentration methanol and reaction by-products of the fuel cell stack to the anode of the fuel cell stack; a QCM concentration sensing unit 200 for measuring the concentration of methanol supplied from the mixing tank 145 to the fuel cell stack 110; and a drive controlling unit 160 for controlling the operation of the fuel cell system according to the sensing results of the QCM concentration sensing unit 200.

Herein, the QCM concentration sensing unit 200 includes a concentration sensor using a quartz crystal microbalance (QCM). The QCM concentration sensor comprises a quartz crystal plate with constant thickness positioned between a pair of electrodes. In order to use the QCM to perform the concentration sensing of fluid, at least a portion of one electrode is dipped into the liquid and a mechanical resonance frequency is measured by means of weak force applied to the electrode. And the force applied to the electrode can be determined from the frequency. The density value of the liquid corresponding to the force is then obtained. Then, the density value is converted to a concentration value for the methanol solution.

The QCM concentration sensor is in measuring the concentration of gases or liquids. In particular, it is very suitable for the methanol concentration measurement of the fuel cell system because the output of the sensor can be adjusted to be approximately constantly proportional to changes in methanol concentration.

In the present embodiment, the QCM concentration sensing unit 200 is installed on a pipe 126 fluidly connecting the anode of the fuel cell stack 110 and the mixing tank 145, and positioned proximal to the anode of the fuel cell stack 110 where it accurately measures the concentration of aqueous methanol supplied to the fuel cell stack 110.

On the other hand, fuel is not supplied to the stack 110 at a constant rate. In other words, the flow velocity of the aqueous methanol flowing through the pipe 126 positioned between the anode of the fuel cell stack 110 and the mixing tank 145 is not constant. That is, it is in a changing state at all times.

Meanwhile, the QCM concentration sensor estimates the concentration from changes in the density of the liquid. Therefore, a change in the physical environment such as a change in the flow velocity can cause an error and/or deviation in the QCM concentration sensing.

The QCM concentration sensing unit 200 of the present embodiment is exemplarily implemented by the fluid sensing pipe including a portion of the pipe 126 positioned between the anode of the fuel cell stack 110 and the mixing tank 145. The fluid sensing pipe has a structure for reducing or preventing the error and/or deviation in the QCM concentration sensing due to an unstable flow velocity.

The illustrated embodiment uses a bypass channel for stably driving the sensor mounted inside of the fuel cell system. The bypass channel buffers the sensor from sudden changes in the flow velocity and flux of fluid.

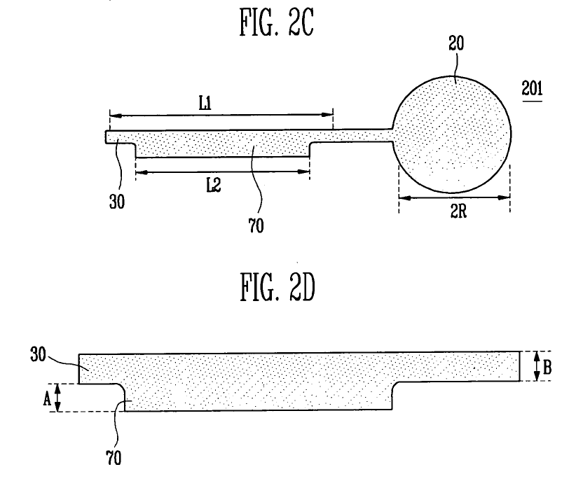

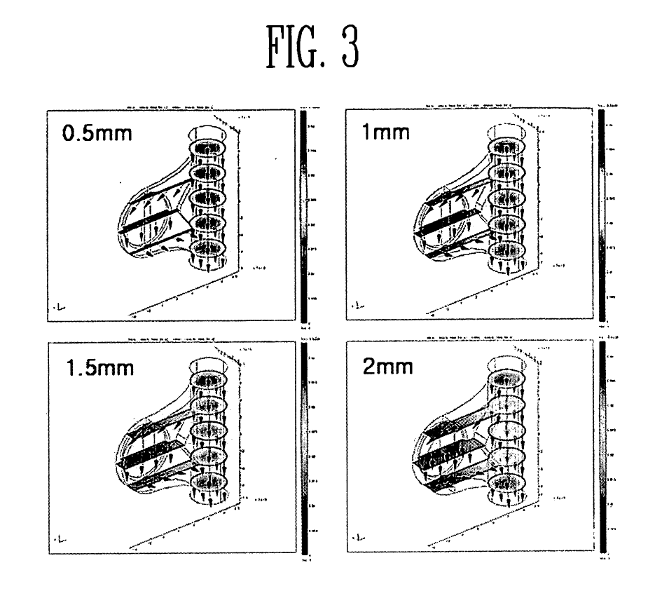

FIGS. 2A to 2D are views for explaining a fluid sensing pipe for a fuel cell system according to one embodiment. As shown in FIGS. 2A to 2D, the fluid sensing pipe 201 of the present embodiment includes a main flow field 20 in which the fluid to be sensed flows; and a bypass channel 30 formed in a plane shape including a liquid flow axis parallel to the main flow field 20 and having the QCM sensor disposed therein.

The main flow field 20 may be a portion of a pipe positioned between the anode of the fuel cell stack 110 and the mixing tank 145. If the fluid sensing pipe 201 of the present embodiment is manufactured as a separate component of length L, it may be the only component coupling the mixing tank and the anode of the fuel cell stack, or as shown in FIG. 2B, the fluid sensing pipe 201 may be coupled to one or more fuel supply pipes coupled to the mixing tank 145 and/or a fuel supply inlet of the fuel cell stack 110.

The structure of bypass channel 30 makes the flow velocity of liquid flowing into the channel substantially constant at all times, while reducing or minimizing the influence on the flow velocity of liquid in the main flow field 20. To this end, in the present embodiment, the bypass channel 30 is disposed in the main flow field through which most liquid field passes, and the concentration sensor is disposed in a portion in the bypass channel 30 where the flow velocity is constant.

As shown in FIG. 2B, the bypass channel 30 includes a fluid inlet part 40 receiving liquid from the main flow field 20, a fluid outlet part 50 returning internal liquid to the main flow field 20, and a partition wall 60 positioned between the bypass channel 30 and the main flow field 20 and separating the fluid inlet part 40 and the fluid outlet part 50.

The middle portion of the bypass channel 30 is wider than the fluid inlet part 40 and the fluid outlet part 50 in order to provide a constant flow velocity by moving some liquid flowing through the main flow field 20. The cross section of the middle region is extended in an approximately perpendicular direction to the fluid flow direction.

Also, the bypass channel 30 has any suitable cross section, for example, a rectangular shape or an oval shape, with a narrow vertical cross section to the fluid flow direction, thereby improving the constancy of the flow velocity and providing a space for installing the QCM sensor in a coin form.

The fluid sensing pipe 201 may have a shape in which a region is widened by a constant size A in communication with the bypass channel 30 as shown in cross section in FIG. 2D. In other words, the fluid sensing pipe 201 of the present embodiment may further include a sensor region 70 in which the QCM sensor will be placed. In some embodiments, the fluid sensing pipe 201 has L1 of about 8 mm and L2 of about 6 mm and a diameter 2R of the main flow field 20 of about 4 mm as shown in cross section in FIGS. 2C and 2D.

The fluid sensing pipe 201 of the present embodiment can change the fluid flow resistance of the bypass channel 30 through changes in the dimensions A and/or B shown in FIG. 2D, thereby permitting the amount of fluid flowing into the bypass channel to be easily controlled.

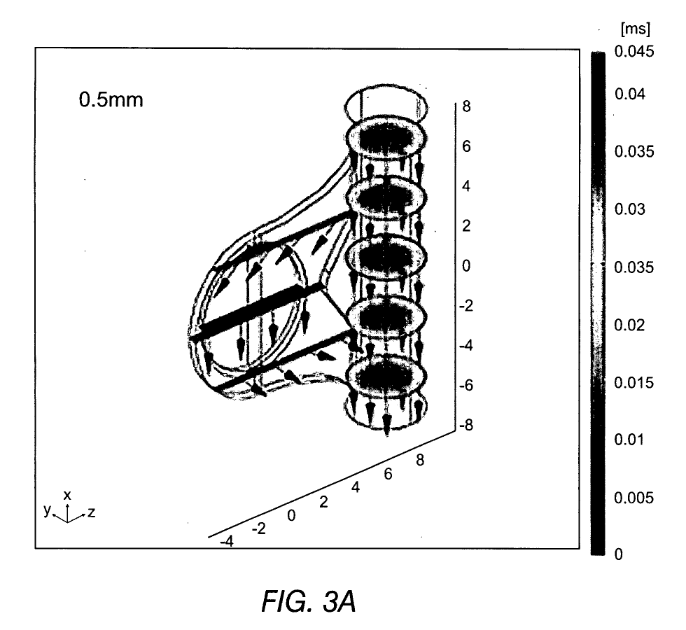

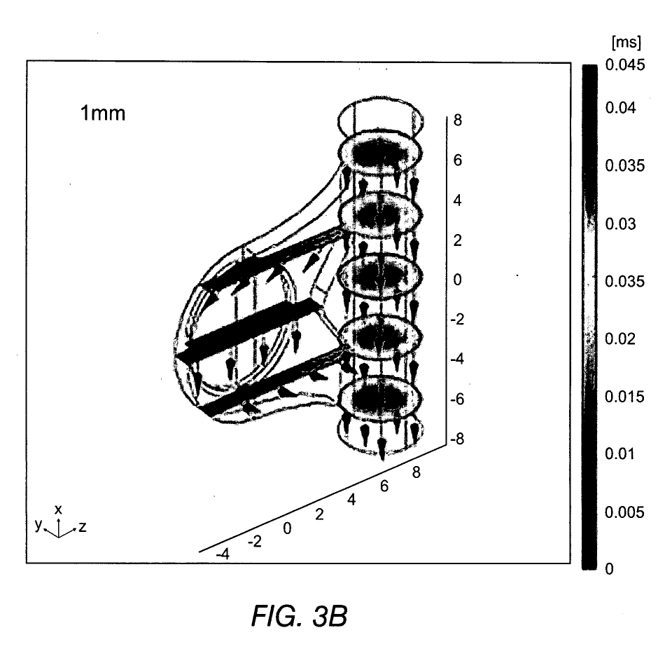

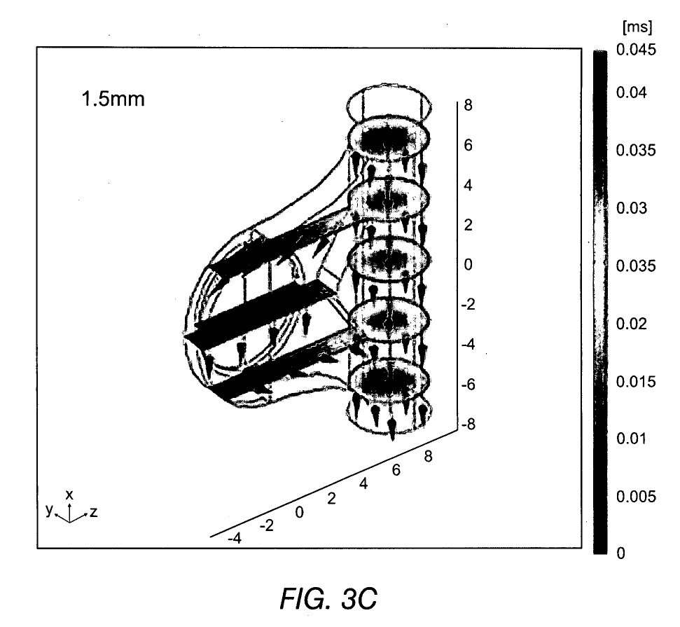

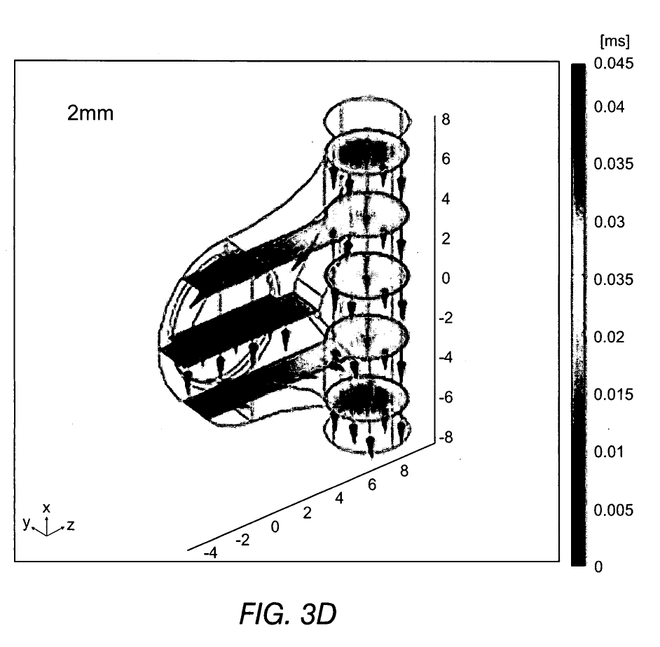

FIG. 3 shows changes in fluid flow with changes the B dimension of the fluid sensing pipe of FIGS. 2C and 2D.

The arrows in FIG. 3 indicate the direction that the fluid is moving and the color indicates the velocity, with red indicating the highest velocity. The scales for each detailed drawing are same, in A.U. (arbitrary units). In other words, relative flow velocity is computed by considering a maximum flow velocity of the main flow field as 100 units. The experimental results described above are set forth in Table 1.

TABLE 1

| | | | Bypass flow |
|---|---|---|---|
| Cell thickness (mm) | Cell Volume (μL) | Bypass flow (%) | rate (μL/min) |
| 0.5 | 39 | 2.4 | 260 |
| 1.0 | 64 | 6.2 | 947 |
| 1.5 | 90 | 13.5 | 2024 |
| 2.0 | 115 | 20.0 | 3101 |

As can be appreciated in FIG. 3 and Table 1, the fluid flows in a constant direction without back flow in the bypass channel. In general, the fluid flows does not significantly change. However, as the thickness B of the cell increases, the flux at the fluid inlet part and the fluid outlet part of the bypass channel increases. Accordingly, in some embodiments, the cell thickness is less than or equal to about 5 mm, about 2 mm, about 1 mm, or about 0.5 mm. In some embodiments, a ratio between a cell thickness and a cell width is at least about 4:1, at least about 8:1, at least about 16:1 or at least about 32:1.

A fluid sensing pipe, which is stable to fluctuations in fluid flux and is not susceptible to bubbles, can be implemented by controlling the design and dimensions of the bypass channel.

The fluid sensing pipe of the present embodiment can be also applied to other sensing structures by installing a QCM sensor as well as a sensor sensitive to the flow velocity in the pipe.

Hereinafter, is described the operation of the direct methanol fuel cell system comprising a QCM concentration sensor as described above. However, the structure and method are not limited to methanol as the fuel, and are applicable to any aqueous liquid fuel, for example, ethanol or acetic acid.

Referring again to FIG. 1, the direct methanol fuel cell includes a stack 110 generating electricity by the electrochemical reaction of hydrogen gas and oxygen, a fuel tank 142 in which high concentration fuel to be supplied to the stack 110 is stored, an air pump 130 for supplying oxidant to the stack 110, a condenser 152 recycling unreacted fuel discharged from the stack 110, and a mixing tank 145 supplying hydrogen-containing fuel, which comprises a mixture of unreacted fuel discharged from the condenser 152 and high concentration fuel discharged from the fuel storing unit 140. Herein, the condenser 152 and the mixing tank 145 together comprise a recycler that recycles and processes the effluents of the stack. The fuel tank 142, the mixing tank 145, and the pumps 146 and 148 together comprise a fuel storing unit 140.

The stack 110 includes a plurality of unit cells, each comprising a membrane electrode assembly comprising a cathode electrode and an anode electrode provided on each side of the polymer membrane. The anode electrode reforms the hydrogen-containing fuel supplied from the fuel storing unit 140 and oxidizes the generated hydrogen gas, thereby generating a proton (H⁺) and electron (e⁻). The cathode electrode combines oxygen from the air supplied by the oxidant supplying unit 130 with the proton and electron to generate water. And, the polymer membrane comprises a polymer electrolyte membrane that suppresses the diffusion of hydrogen-containing fuel therethrough, while permitting ion-exchange transmission of the protons generated at the anode electrode to the cathode electrode. In this case, the polymer electrolyte membrane has a thickness of from about 50 μm to about 200 μm.

The electric energy generated from the electrochemical reaction between hydrogen gas and oxygen in the unit cell is converted to allow the current/voltage to be matched with an output standard by a power conversion device 170. According to the illustrated embodiment, the power conversion device 170 may charge a separately provided secondary battery as well as supply power to the drive controlling unit 160.

Carbon dioxide (CO₂), water (H₂O), and unreacted fuel from the fluid outlet of the stack 110 flows to the condenser 152. The unreacted fuel and water condensed in the condenser 152 is collected in the mixing tank 145. The carbon dioxide can be discharged to the outside through an exhaust hole in the mixing tank 145. The unreacted fuel collected in the mixing tank 145 and high concentration fuel supplied from the fuel tank 142 are mixed and then supplied to the anode electrode of the stack 110.

The oxidant supplying unit may comprise an air pump 130 for supplying air to the cathode electrode of the stack 110 or may comprise a passive vent hole providing a smooth air flow.

The drive controlling unit 160 controls the operation of the pump 148 for the fuel tank and the pump 146 supplying the mixed fuel to the stack 110. In addition to the pumps described above, the drive controlling unit 160 can control the operation of one or more pumps provided on a pipe 123 from the cathode of the stack 110 to the condenser 152, a pipe 124 from the condenser 152 to the mixing tank 145, and/or a pipe 122 from the anode of the stack 110 to the mixing tank 145.

The drive controller 160 exemplarily includes a digital processor. In this case, the digital processor comprises a reference clock. In some embodiments, the drive controlling unit 160 comprises a single processor that processes the sensed value of the QCM concentration sensor and determines the fuel concentration therefrom, as well as performs drive control of the fuel cell in order to reduce hardware.

In other words, the drive controlling unit 160 controls a first pump 148 that comprises a first flux controller controlling the flow of high concentration methanol from the fuel tank to the mixing tank, a second pump 146 that comprises a second flux controller controls the flow of a mixed liquid fuel from the mixing tank to the anode of the fuel cell stack, and a condenser 152 that comprises a third flux controller controlling the flow of reaction by-products to the mixing tank.

The input data required for controlling the operation of the pumps 146 and 148, and the condenser 152 by the drive controlling unit 160 may be a concentration value of each portion of the fuel cell, a generation power state (current, voltage, or the like) of the power conversion device, the temperature value of each portion, etc. Therefore, the QCM concentration sensing unit 200 may be installed in system components such as the mixing tank 145, or in one or more liquid flow paths such as the pumps 146 and 148, etc., the pipe 123 from the cathode to the condenser 152, the pipe 124 from the condenser 152 to the mixing tank 145, the pipe 122 from the anode to the mixing tank 145, the pipes 127 and 128 from the fuel tank 142 to the mixing tank 145, and the input/output pipes 125 and 126 of the pump 146, in addition to the location shown.

The operation of the drive controlling unit 160 controls the air pump 130 as the oxidant supplying unit, the condenser 152, and the pump 146. An embodiment in which a concentration sensor is provided in the mixing tank 145 is briefly described.

When the output power of the power conversion device 170 is below a predetermined value, the drive controlling unit 160 operates the pump 146, thereby increasing fuel supply amount to the fuel cell stack 110 and increasing the amount of electricity generated thereby. Meanwhile, when the fuel concentration in the mixing tank 145 becomes lower than a predetermined value, the drive controlling unit 160 increases the rate of operation of the condenser 152 to increase the condensed amount of unreacted fuel, and/or operates the pump 148 to increase the supply of high-concentration fuel from the fuel storing unit 142. On the other hand, when the fuel concentration in the mixing tank 145 becomes higher than a predetermined value, the drive controlling unit 160 reduces the rate of operation of the condenser 152 to reduce the condensed amount of unreacted fuel and/or reduces the supply of high concentration fuel from the fuel tank 142 by means of the pump 148. As a result, the efficiency of electricity generation of the fuel cell system is stably maintained by constantly maintaining the concentration of hydrogen-containing fuel supplied from the mixing tank 145 to the anode electrode of the stack 110.

A fuel cell system capable of accurately measuring the fuel concentration at a low cost can be provided by a fuel cell system including the QCM concentration sensor as described above.

Also, the QCM concentration sensor can be small, thereby providing a small fuel cell system having high operation efficiency and improved design freedom.

Also, the concentration of liquid-phase fuel may be accurately measured with a small concentration sensor in the pipe for a fluid having non-uniform flow velocity.

Although exemplary embodiments have been shown and described, it would be appreciated by those skilled in the art that changes might be made in these embodiments without departing from the principles and spirit thereof, the scope of which is defined in the claims and their equivalents.

What is claimed is:

1. A fluid-sensing device for measuring a fuel concentration in a fuel cell system, the fluid-sensing device comprising:
a main flow field comprising a first end and a second end, and configured for transferring fluid to be sensed from the first end to the second end;
a bypass channel fluidly connected to the main flow field, and configured for diverting and returning a portion of fluid therefrom; and
a fluid sensor disposed in the bypass channel.

2. The fluid-sensing device of claim 1, wherein the sensor is disposed in a middle region of the bypass channel.

3. The fluid-sensing device of claim 1, wherein the bypass channel comprises:
a fluid inlet fluidly coupled proximal to the first end of the main flow field and configured for receiving fluid from the main flow field;
a fluid outlet fluidly coupled proximal to the second end of the main flow field and configured for discharging fluid to the main flow field; and
a partition wall disposed between the bypass channel and the main flow field.

4. The fluid-sensing device of claim 3, wherein a cross section of a middle region of the bypass channel is wider than a cross section of the fluid inlet and a cross section of the fluid outlet.

5. The fluid-sensing device of claim 1, wherein the sensor comprises a quartz crystal microbalance (QCM) sensor.

6. The fluid-sensing device of claim 1, wherein the bypass channel comprises at least one of a rectangular cross section and an oval cross section with respect to the direction of fluid flow, and a vertical dimension of the cross section is narrower than a horizontal dimension of the cross section.

7. The fluid-sensing device of claim 1, further comprising a sensor region in fluid communication with a wide portion of the bypass channel.

8. A fuel cell system comprising:
a fuel cell comprising a fuel cell stack operable for generating electric energy by an electrochemical reaction between a hydrogen-containing fuel and oxidant; and a fuel supplying unit fluidly coupled to the fuel cell stack, operable for supplying the hydrogen-containing fuel to the fuel cell stack;
a QCM concentration sensing unit comprising a QCM concentration sensor in fluid communication with a fluid in the fuel cell stack, operable for measuring a concentration of the fluid in the fuel cell; and
a drive controlling unit coupled to the QCM concentration sensing unit, operable for controlling the operation of the fuel cell according to an output of the QCM concentration sensing unit.

9. The fuel cell system of claim 8, wherein the QCM concentration sensing unit comprises a main flow field comprising a first end and a second end, and configured for transferring fluid to be sensed from the first end to the second end; a bypass channel fluidly connected to the main flow field, and configured for diverting and returning a portion of the fluid therefrom; and a QCM concentration disposed in the bypass channel.

10. The fuel cell system of claim 9, wherein the sensor is disposed in a middle region of the bypass channel.

11. The fuel cell system of claim 9, wherein the bypass channel comprises:
a fluid inlet fluidly coupled proximal to the first end of the main flow field and configured for receiving fluid from the main flow field;
a fluid outlet fluidly coupled proximal to the second end of the main flow field and configured for discharging fluid to the main flow field; and
a partition wall disposed between the bypass channel and the main flow field.

12. The fuel cell system of Claim aim 11, wherein a cross section of a middle region of the bypass channel is wider than a cross section of the fluid inlet and a cross section of the fluid outlet.

13. The fuel cell system of claim 8, wherein the QCM concentration sensing unit comprises a fluid sensing device comprising the QCM sensor disposed therein.

14. The fuel cell system of claim 9, wherein the bypass channel comprises at least one of a rectangular cross section and an oval cross section respect to the direction of fluid flow, and a vertical dimension of the cross section is narrower than a horizontal dimension.

15. The fuel cell system of claim 9, further comprising a sensor region in fluid communication with a wide portion of the bypass channel.

16. The fuel cell system of claim 9, wherein the fuel supplying unit comprises:
a fuel tank configured for storing high concentration methanol; and
a mixing tank in fluid communication with the fuel tank and the fuel cell stack, wherein the mixing tank is configured for mixing water and/or unreacted fuel from the fuel cell stack with high concentration methanol from the fuel tank, and supplying the mixed fuel liquid fuel to the fuel cell stack.

17. The fuel cell system of claim 16, wherein the main flow field comprises a portion of a pipe or conduit fluidly connecting the mixing tank to an anode of the stack.

18. The fuel cell system of claim 16, wherein the fuel supplying unit further comprises:
a first flux controller configured for controlling a flow of high concentration methanol from the fuel tank to the mixing tank;
a second flux controller configured for controlling a flow of a mixed fuel liquid fuel from the mixing tank to an anode of the fuel cell stack; and
a third flux controller configured for controlling a flow of fluid from the fuel cell stack to the mixing tank,
wherein the drive controlling unit controls at least one of the first to third flux controllers according to an output of the QCM concentration sensing unit.

19. The fuel cell system of claim 18, wherein the third flux controller comprises a condenser fluidly connected to an exhaust outlet of the fuel cell stack and the mixing tank, and configured for condensing fluid from the fuel cell stack into the mixing tank.

20. The fuel cell system of claim 9, further comprising an air pump fluidly connected to the cathode of the fuel cell stack.
